(19) United States
(12) Patent Application Publication
(10) Pub. No.: US 2014/0005328 A1
(43) Pub. Date: Jan. 2, 2014

(54) POLYAMIDE-IMIDE RESIN COMPOSITION, POLYAMIDE-IMIDE RESIN FILM USING THE RESIN COMPOSITION, AND SEAMLESS BELT INCLUDING THE RESIN FILM

(71) Applicant: NITTO DENKO CORPORATION, Osaka (JP)

(72) Inventors: Shunsuke MASAKI, Osaka (JP); Hisae KITAGAWA, Osaka (JP)

(21) Appl. No.: 13/927,868

(22) Filed: Jun. 26, 2013

(30) Foreign Application Priority Data
Jun. 27, 2012 (JP) 2012-144173
May 2, 2013 (JP) 2013-096801

(51) Int. Cl. C08L 79/08; C08G 73/14

(52) U.S. Cl. CPC C08L 79/08; C08G 73/14
USPC 524/590; 528/73

(57) ABSTRACT

A polyamide-imide resin composition according to embodiment of the present invention, including a polyamide-imide resin obtained by causing acid components (A) containing a dimer acid and a polyisocyanate component (B) to react with each other, wherein a ratio of the dimer acid in the acid components (A) is 3 mol % to 55 mol %.

This application claims priority under 35 U.S.C. Section 119 to Japanese Patent Application No. 2012-144173 filed on Jun. 27, 2012, which are herein incorporated by references.

### BACKGROUND OF THE INVENTION

1. Field of the Invention

The present invention related to a polyamide-imide resin composition, a polyamide-imide resin film using the resin composition, and a seamless belt including the resin film.

2. Description of the Related Art

A polyamide-imide resin is a resin having an amide bond and an imide bond in its molecular framework. An isocyanate method involving using trimellitic anhydride and a diisocyanate has been frequently employed as a method of producing the polyamide-imide resin in terms of productivity (for example, Japanese Patent Application Laid-open No. Hei 4-34912 and Japanese Patent Application Laid-open No. Hei 1-284555). When a film using the polyamide-imide resin is formed, a method involving applying a resin composition containing the resultant polyamide-imide resin to a substrate and drying the composition is generally employed in ordinary cases.

The film containing the polyamide-imide resin is suitably used in an application where the temperature of the film may be high at the time of its use (such as a seamless belt of a printing machine or the like, an electronic part, or a coil of electrical equipment) because the film is excellent in heat resistance. However, when the amount of a solvent remaining in the film to be used is large, a gas (outgas) may be generated from the film owing to the volatilization of the remaining solvent at the time of, for example, its use at high temperature. The outgas may be responsible for malfunctions and failures in various apparatus. In addition, the solvent remaining in the film may be discharged as the outgas with time as well. Accordingly, a film having a small remaining solvent amount has been required. In addition, a film having mechanical characteristics, in particular, excellent flexibility (rupture elongation) has been required in terms of practical durability in various applications and the processability of the film suitable for a desired application.

### SUMMARY OF THE INVENTION

The present invention has been made to solve the conventional problems, and an object of the present invention is to provide a polyamide-imide resin composition capable of providing a film having excellent flexibility (rupture elongation) and reduced in remaining solvent amount.

The inventors of the present invention have made extensive studies, and as a result, have found that the object can be achieved by using the following polyamide-imide resin composition. Thus, the inventors have completed the present invention.

A polyamide-imide resin composition according to embodiment of the present invention, including a polyamide-imide resin obtained by causing acid components (A) containing a dimer acid and a polyisocyanate component (B) to react with each other, wherein a ratio of the dimer acid in the acid components (A) is 3 mol % to 55 mol %.

In an embodiment of the present invention, the acid components (A) include a hydrogenated dimer acid.

In an embodiment of the present invention, the polyisocyanate component includes an aromatic diisocyanate.

In an embodiment of the present invention, the acid components (A) further include a tricarboxylic anhydride and a ratio of the tricarboxylic anhydride in the acid components (A) is 90 mol % to 97 mol %.

According to another aspect of the present invention, a polyamide-imide resin film is provided. The polyamide-imide resin film is obtained by using the polyamide-imide resin composition.

In an embodiment of the present invention, the polyamide-imide resin film has a rupture elongation of 60% or more.

In an embodiment of the present invention, the polyamide-imide resin film has a remaining solvent amount of 2% or less.

According to another aspect of the present invention, a seamless belt is provided. The seamless belt includes the polyamide-imide resin film.

The polyamide-imide resin composition of the present invention contains 3 mol % to 55 mol % of the dimer acid in the acid components (A) to be used for obtaining the polyamide-imide resin. Accordingly, a polyamide-imide resin composition capable of providing a film having excellent flexibility (rupture elongation) and reduced in remaining solvent amount is obtained. Therefore, the resultant polyamide-imide resin film is excellent in processability and has high practical durability. Moreover, in the film obtained by using the polyamide-imide resin of the present invention, the remaining solvent amount of the film is reduced, and hence the generation of an outgas from the film is suppressed and a failure of an apparatus provided with the film can be prevented.

The film obtained by using the polyamide-imide resin of the present invention is suitable as, for example, a seamless belt to be placed in a printing machine, a copying machine, or the like (such as an intermediate transfer belt, a fixing belt, or a conveying belt), a heat-resistant film to be used in an electronic part, an insulating coating material of electrical equipment or the like (such as a coating material for a coil), or a carrier film to be used under a vacuum or under a high temperature because the film exerts the effects.

### DETAILED DESCRIPTION OF THE PREFERRED EMBODIMENTS

<A. Polyamide-Imide Resin Composition>

A polyamide-imide resin composition of the present invention includes a polyamide-imide resin obtained by causing acid components (A) containing a dimer acid and a polyisocyanate component (B) to react with each other. The polyamide-imide resin contains 3 mol % to 55 mol % of the dimer acid in the acid components (A) to be used in the reaction. Accordingly, a polyamide-imide resin composition capable of providing a film having excellent flexibility (rupture elongation) and reduced in remaining solvent amount can be provided.

<A-1. Polyamide-Imide Resin>

The polyamide-imide resin is obtained by causing any appropriate acid components (A) containing the dimer acid and any appropriate polyisocyanate component (B) to react with each other. In the present invention, the isocyanate method is employed because of its excellent working efficiency.

A compounding ratio between the acid components (A) and the polyisocyanate component (B) to be used in the synthesis of the polyamide-imide resin can be set to any appropriate ratio. The compounding ratio between the acid components (A) and the polyisocyanate component (B) is preferably such that the amount of the polyisocyanate component (B) is 0.5 mole to 2.0 moles with respect to 1 mole of the acid components (A), and the compounding ratio is more preferably such that the amount of the acid components (A) is equivalent to that of the polyisocyanate component (B).

The number-average molecular weight of the polyamide-imide resin is preferably 5,000 to 50,000, more preferably 8,000 to 30,000. When the number-average molecular weight of the polyamide-imide resin falls within the range, film forming can be easily performed and hence a film having an excellent rupture elongation can be provided.

<A-1-1. Acid Components (A)>

The dimer acid and any appropriate other acid component are used as the acid components (A). The incorporation of 3 moles to 55 moles of the dimer acid with respect to 100 moles of the acid components (A) provides a polyamide-imide resin composition capable of providing a film having excellent flexibility (rupture elongation) and reduced in remaining solvent amount.

As described above, the ratio of the dimer acid in the acid components (A) is 3 mol % to 55 mol %. When the ratio of the dimer acid in the acid components (A) is 3 mol % or more, a polyamide-imide resin composition capable of providing a film having excellent flexibility (rupture elongation) and reduced in remaining solvent amount can be provided. When the ratio of the dimer acid in the acid components (A) is 55 mol % or less, the pot life of a solution (varnish) containing the polyamide-imide resin is lengthened and hence high polymerization reactivity of the polyamide-imide resin can be secured. Further, the mechanical characteristics of the resultant film such as a modulus of elasticity can further improve. The ratio of the dimer acid in the acid components (A) is preferably 7 mol % or more, more preferably 15 mol % or more. The ratio of the dimer acid in the acid components (A) is preferably 52 mol % or less, more preferably 40 mol % or less.

<A-1-1-1. Dimer Acid>

The dimer acid is a compound obtained by an intermolecular polymerization reaction between two or more unsaturated fatty acids. The use of the dimer acid as the acid components (A) provides a polyamide-imide resin composition capable of providing a film having excellent flexibility (rupture elongation) and reduced in remaining solvent amount. The reason why such effect is obtained is considered as described below. The molecular structure of the dimer acid is so bulky that the free volume of the molecular chain of the polyamide-imide resin into which the dimer acid is introduced may be large. Accordingly, the removal of a solvent from the film becomes easy as compared with a polyamide-imide resin using only a monomer component having an aromatic group and hence the remaining solvent amount of the resultant film may be reduced. Further, excessive cross-linking between the molecules of the polyamide-imide resin in the step of removing the solvent from the film (such as the step of drying the film) is suppressed and hence a polyamide-imide resin film having an excellent rupture elongation may be able to be provided. In addition, the polyamide-imide resin using the dimer acid as the acid components (A) contains a long-chain alkyl group having high hydrophobicity in its molecular structure and hence the moisture absorption characteristic of the resultant film may be reduced. Accordingly, the film using the polyamide-imide resin of the present invention may have excellent dimensional stability even under an environment where a humidity change may occur.

Examples of the unsaturated fatty acids include linear or branched unsaturated fatty acids each having 8 or more (preferably 16 to 22, more preferably 16 to 20, still more preferably 18) carbon atoms. Specific examples of the unsaturated fatty acids include oleic acid, linoleic acid, elaidic acid, palmitoleic acid, linolenic acid, 3-octenoic acid, and 10-undecenoic acid. Of those, oleic acid is preferred. The use of a long-chain dimer acid obtained by bonding two molecules of oleic acid makes the effect significant. In addition, the use of the dimer acid can provide a polyamide-imide resin composition capable of providing a film additionally excellent in mechanical characteristics such as a tensile strength as well as flexibility (rupture elongation).

The number of carbon atoms of the dimer acid is preferably 16 or more, more preferably 32 to 40, still more preferably 36. The structure of the dimer acid is not particularly limited, and any one of an acyclic structure, a monocyclic structure, a polycyclic structure, and an aromatic ring-type structure may be used. Only a dimer acid having any one of the structures may be used as the dimer acid, or two or more kinds of dimer acids having different structures may be used in combination. The dimer acid may be a hydrogenated dimer acid. The hydrogenated dimer acid is preferably used as the dimer acid. The hydrogenated dimer acid can be used in a state of being free of a double bond having reaction activity and hence the polymerization reaction of the polyamide-imide resin is stable. As a result, a polyamide-imide resin composition excellent in storage stability can be obtained. The hydrogenated dimer acid and a dimer acid that is not hydrogenated may be used in combination as the dimer acid.

As the dimer acid, a commercially available dimer acid may be used. Examples thereof include a “PRIPOL” series manufactured by Croda Japan, a “HARIDIMER” series manufactured by Harima Chemicals, an “EMPOL” series manufactured by BASF Japan Ltd., and a “Tsunodyme” series manufactured by TSUNO CO., LTD. Those commercially available dimer acids may be used alone or in combination. Each of the commercially available dimer acids can typically contain small amounts of a monomer acid and a trimer acid in addition to the dimer acid. When any one of the commercially available dimer acids is used, the acid can be used as it is without being further subjected to a purifying step or the like.

<A-1-1-2. Acid Component Except Dimer Acid>

Any appropriate acid component can be used as the acid component except the dimer acid. Examples of the acid component except the dimer acid include a tricarboxylic anhydride, a tetracarboxylic dianhydride, an aromatic dicarboxylic acid, an alicyclic dicarboxylic acid, and an aliphatic dicarboxylic acid. Specific examples thereof include: tricarboxylic anhydrides such as trimellitic anhydride and cyclohexanetricarboxylic anhydride; tetracarboxylic dianhydrides such as pyromellitic anhydride, biphenyltetracarboxylic dianhydride, and oxydiphthalic anhydride; aromatic dicarboxylic acids such as terephthalic acid and isophthalic acid; alicyclic dicarboxylic acids such as cyclohexanedicarboxylic acid; and aliphatic dicarboxylic acids such as adipic acid and sebacic acid. The acid components except the dimer acid may be used alone or in combination. A tricarboxylic anhydride is preferred as the acid component except the dimer acid in terms of reactivity, solubility, heat resistance, and a cost. In addition, the use of the tricarboxylic anhydride can provide a polyamide-imide resin whose moisture absorption characteristic is suppressed. Trimellitic anhydride can be more preferably used because of the following reasons: trimellitic anhydride has high general-purpose property and easily reduces the cost. In one embodiment, the ratio of the tricarboxylic anhydride in the acid components (A) is preferably 45 mol % to 97 mol %, more preferably 90 mol % to 97 mol %. In such embodiment, the ratio of the dimer acid in the acid components (A) is preferably 3 mol % to 55 mol %, more preferably 3 mol % to 10 mol %.

<A-1-2. Polyisocyanate Component (B)>

Any appropriate isocyanate component can be used as the polyisocyanate component (B). Examples of the polyisocyanate component (B) include an aromatic diisocyanate, an aliphatic isocyanate, and an alicyclic isocyanate. Specific examples thereof include: aromatic diisocyanates such as 4,4′-diphenylmethane diisocyanate, tolylene diisocyanate, tetramethylxylene diisocyanate, and 3,3′-dimethylbiphenyl-4,4′-diisocyanate; aliphatic diisocyanates such as hexamethylene diisocyanate; and alicyclic diisocyanates such as isophorone diisocyanate, hydrogenated xylylene diisocyanate, norbornene diisocyanate, and dicyclohexylmethane diisocyanate. An aromatic diisocyanate is preferred as the polyisocyanate component (B). The use of the aromatic diisocyanate can provide a polyamide-imide resin capable of forming a film excellent in mechanical strengths such as a modulus of elongation and a breaking strength. The isocyanates may be used alone or in combination.

<A-1-3. Method Of Producing Polyamide-Imide Resin>

The polyamide-imide resin can be obtained by causing the acid components (A) containing the dimer acid and the polyisocyanate component (B) to react with each other in any appropriate solvent. Examples of the solvent include N-methyl-2-pyrrolidone, N, N-dimethylacetamide, and γ-butyrolactone. Those solvents may be used alone or as a mixture. The reaction temperature and the reaction time have only to be appropriately set. For example, the reaction temperature can be set to 100° C. to 250° C. and the reaction time can be set to 3 hours to 20 hours.

A catalyst may be used for the synthesis of the polyamide-imide resin as required. Any appropriate catalyst may be used as the catalyst. Examples of the catalyst include diazabicycloundecene, triethylenediamine, potassium fluoride, and cesium fluoride. The addition amount of the catalyst can be set to any appropriate value depending on, for example, the loading amounts of the materials to be used in the reaction and the reaction conditions.

<A-2. Additive>

The polyamide-imide resin composition of the present invention can further contain any appropriate additive in addition to the polyamide-imide resin. Examples of the additive include: a conductive filler; silica; a metal oxide such as alumina or titania; an inorganic filler such as clay or mica; a surfactant for dispersing these additives in the polyamide-imide resin composition; and a coupling agent. Those additives may be used alone or in combination.

As described above, the resin composition containing the polyamide-imide resin to be used in the present invention can be formed into a film by easily removing the solvent at a low temperature and within a short time period as compared with a conventional polyamide-imide resin composition. Accordingly, even an organic substance or the like that decomposes at a high temperature can be suitably used as an additive. Examples of such additive include: a polyaniline and a polythiophene to be used as conductive fillers; a surfactant to be used for improving the dispersibility of an inorganic filler; and a coupling agent.

The polyamide-imide resin composition of the present invention preferably further contains a conductive filler. When the resin composition contains the conductive filler, desired electrical characteristics can be imparted to a film obtained by using the resin composition. Any appropriate conductive filler may be used as the conductive filler. Examples thereof include: inorganic compounds such as carbon black, aluminum, nickel, tin oxide, and potassium titanate; and conductive polymers such as a polyaniline and a polypyrrole. Of those, a polyaniline is preferred in terms of being able to provide a film having good mechanical characteristics.

The content of the conductive filler in the polyamide-imide resin composition can be set to any appropriate value depending on the desired electrical characteristics and desired mechanical characteristics. The content of the conductive filler is preferably 0.5 part by weight to 30 parts by weight, more preferably 1 part by weight to 25 parts by weight with respect to 100 parts by weight of the polyamide-imide resin.

The solid matter content of the polyamide-imide resin composition can be appropriately set depending on a method of producing the film. The solid matter content of the polyamide-imide resin composition can be set to, for example, 15 wt % to 35 wt %. The solid matter content of the polyamide-imide resin composition can be adjusted by adding any appropriate organic solvent to the reaction solution of the polyamide-imide resin. For example, the solvent to be used in the reaction of the polyamide-imide resin can be used as the organic solvent.

### <B. Polyamide-Imide Resin Film>

A polyamide-imide resin film of the present invention is obtained by using the polyamide-imide resin composition. Therefore, the polyamide-imide resin film of the present invention has an excellent rupture elongation, and is excellent in processability into a seamless belt or the like and practical durability in various applications. Accordingly, the film can be suitably used in a seamless belt such as an intermediate transfer belt, fixing belt, or conveying belt to be used in a copying machine or the like. In addition, the polyamide-imide resin film of the present invention has a small remaining solvent amount. Accordingly, when the polyamide-imide resin film of the present invention is applied to various applications, the occurrence of a malfunction or failure of an apparatus due to the generation of an outgas from the resin film can be suppressed. Further, even when the polyamide-imide resin film of the present invention is used under a vacuum or under a high temperature, the generation of the outgas from the resin film is suppressed. Therefore, even when the resin film is used under any such condition, an adverse effect due to the generation of the outgas from the resin film can be prevented. Accordingly, the polyamide-imide resin film of the present invention can be suitably used as each of a carrier film to be used under a vacuum or under a high temperature, and an insulating coating material of electrical equipment or the like as well.

The polyamide-imide resin film of the present invention has a rupture elongation of preferably 60% or more, more preferably 65% or more. When the rupture elongation of the polyamide-imide resin film is 60% or more, the film is easy to handle and has sufficient processability. In addition, the film is excellent in practical durability upon its application to various applications. An upper limit for the rupture elongation of the polyamide-imide resin film is, for example, 200%. When the rupture elongation of the polyamide-imide resin film exceeds 200%, a malfunction may be liable to occur in its practical use. The rupture elongation of the polyamide-imide resin film is a value obtained by subjecting a sample, which is punched out of the film having a thickness of 75 μm with a dumbbell No. 3, to measurement with a Tensilon Universal Tester (manufactured by Toyo Baldwin) at a tension speed of 100 mm/min.

The polyamide-imide resin film of the present invention has a remaining solvent amount of preferably 2% or less, more preferably 1% or less. When the remaining solvent amount is 2% or less, the remaining solvent amount of the polyamide-imide resin film is sufficiently reduced and hence the generation of an outgas from the film is prevented. In addition, for example, even when the film is placed in an apparatus, the occurrence of a malfunction or failure in the apparatus can be prevented. The term “remaining solvent amount” as used herein refers to a value calculated as described below. A circular sample (having a diameter of 4 mm) is cut out of the resin film having a thickness of 75 μm, the temperature of the sample is increased to 500° C. with a thermal analyzer (such as an apparatus available under the trade name “TG-DTA 2000SA” from Bruker AXS) at a rate of temperature increase of 10° C./min, and the remaining solvent amount is calculated from its weight reduction amount at the time of the temperature increase from 120° C. to 300° C. according to the following equation.

Remaining solvent amount(%)=weight reduction amount/sample weight before heating×100

The polyamide-imide resin film of the present invention has a hygroscopic expansion coefficient of preferably 70 ppm/% RH or less, more preferably 50 ppm/% RH or less. In addition, the hygroscopic expansion coefficient is preferably 1 ppm/% RH or more for practicality. When the hygroscopic expansion coefficient of the polyamide-imide resin film falls within the range, the film is excellent in dimensional stability even under an environment where a humidity change may occur. The term “hygroscopic expansion coefficient” as used herein refers to a value calculated as described below. A sample measuring 25 mm by 4 mm punched out of the film is set in an apparatus for thermomechanical analysis whose chuck-to-chuck distance has been set to 20 mm (such as an apparatus available under the trade name “TMA 4000SA” from Bruker AXS). After that, the sample is sufficiently dried under an environment having a temperature of 30° C. and a humidity of 20% RH. Next, the humidity is increased to 80% RH and then the hygroscopic expansion coefficient is calculated from a dimensional change with respect to an initial length at the time of measurement under the following conditions according to the following equation.

Measurement mode: A tension method
Tension load: 4 g
Measurement atmosphere: A temperature of 30° C. and a humidity of 80% RH
Measuring time: 660 minutes
Hygroscopic expansion coefficient=(elongation of sample/initial length of sample)/amount of humidity change

The thickness of the polyamide-imide resin film of the present invention can be appropriately set depending on applications and the like. The thickness of the polyamide-imide resin film of the present invention is, for example, 25 μm to 150 μm, preferably 50 μm to 100 μm.

The polyamide-imide resin film of the present invention can be produced by any appropriate method. The polyamide-imide resin film of the present invention can be obtained by, for example, applying the polyamide-imide resin composition to any appropriate base material to produce a coating film and removing a solvent from the coating film to dry the coating film. Examples of the base material include glass, a metal, and a polymer film. Any appropriate method can be employed as a method of applying the polyamide-imide resin composition to the base material. The method of applying the polyamide-imide resin composition to the base material is, for example, a solvent casting method. A drying temperature for the polyamide-imide resin film is, for example, 100° C. to 300° C., preferably 150° C. to 250° C. In addition, a drying time is preferably 10 minutes to 60 minutes.

In addition, a resin film for a seamless belt can be produced by using a cylindrical mold as the base material. The resin film for a seamless belt is produced by, for example, supplying the polyamide-imide resin composition into the cylindrical mold to form a coating film on the inner surface of the mold and then removing a solvent by a heating treatment to dry the coating film. Any appropriate method is adopted as a method of forming the coating film at the time of the production of the resin film for a seamless belt. Examples thereof include: a method involving supplying an application liquid into the mold, which is rotating, and turning the liquid into a uniform coating film with a centrifugal force; a method involving inserting a nozzle along the inner surface of the mold and ejecting the application liquid from the nozzle into the mold, which is rotating, to spirally apply the liquid while running the nozzle or the mold; a method involving roughly performing the spiral application and then running a running body (of a bullet shape or a spherical shape) having a constant clearance between itself and the mold; a method involving immersing the mold in the application liquid to form an applied film on its inner surface, followed by film forming with a cylindrical die or the like; and a method involving supplyingthe application liquid to one end portion of the inner surface of the mold and then running the running body (of a bullet shape or a spherical shape) having a constant clearance between itself and the mold. A temperature for the heating treatment is preferably 100° C. to 300° C., more preferably 150° C. to 250° C. A time period for the heating treatment is preferably 10 minutes to 60 minutes.

<C. Seamless Belt>

A seamless belt of the present invention includes the polyamide-imide resin film. The polyamide-imide resin film obtained by using the polyamide-imide resin using the acid components containing the dimer acid has an excellent rupture elongation. Accordingly, the film can be easily processed into the seamless belt. Further, the film can be suitably used in various applications because the film is excellent in practical durability as well. In addition, the polyamide-imide resin film is reduced in remaining solvent amount. Accordingly, even when the seamless belt of the present invention is applied to any one of the applications where the temperature of the belt may be high at the time of its use such as an intermediate transfer belt, fixing belt, and conveying belt of a copying machine or the like, a malfunction, failure, and the like of the apparatus due to the generation of an outgas can be prevented. The seamless belt of the present invention may include any appropriate other layer except the polyamide-imide resin film depending on applications. Examples of the appropriate other layer include an inorganic metal oxide thin layer for imparting abrasion resistance and a layer containing fluorine resin powder or ceramic powder for adjusting sliding property. In addition, when the seamless belt is used as a release belt, a release layer formed of a fluorine resin, a silicone rubber, or the like is given as an example thereof.

The thickness of the seamless belt can be appropriately set depending on applications and is typically 50 μm to 150 μm, more preferably 60 μm to 100 μm.

When the seamless belt of the present invention is obtained by using the polyamide-imide resin composition containing the conductive filler, the surface resistivity of the seamless belt is, for example, 1×10⁸Ω/□ to 1×10¹²Ω/□, preferably 1×10⁹Ω/□ to 1×10¹²Ω/□. In addition, the volume resistivity of the seamless belt is, for example, 1×10⁸ Ω·cm to 1×10¹² Ω·cm, preferably 1×10⁹ Ω·cm to 1×10¹² Ω·cm.

Hereinafter, the present invention is specifically described by way of examples. However, the present invention is by no means limited to these examples. It should be noted that the term “part (s)” means “part(s) by weight.”

### Example 1

0.95 Mole of trimellitic anhydride (TMA) and 0.05 mole of a dimer acid (DIA) (manufactured by Croda Japan, trade name: PRIPOL 1009) as the acid components (A), 1.00 mole of 4,4′-diphenylmethane diisocyanate (MDI) as the polyisocyanate component (B), and 1,120 parts by weight of N-methyl-2-pyrrolidone (NMP) as a solvent were loaded into a four-necked flask equipped with a mechanical stirrer with a stirring blade, and then the mixture was subjected to a reaction at 120° C. for 2 hours. Next, 0.01 mole of diazabicycloundecene (DBU) as a catalyst was added to the resultant. The temperature was increased to 180° C. and then the mixture was subjected to a reaction for 3 hours to provide a varnish.

The resultant varnish was applied to a glass substrate, and then the glass substrate was heated in a high-temperature thermostat at 80° C. for 15 minutes and at 150° C. for 15 minutes. After the heating, the glass substrate was cooled to room temperature and then the applied varnish was released from the glass substrate to provide a film. An end portion of the resultant film was fixed and then the film was further heated at 240° C. for 15 minutes to provide a polyamide-imide resin film (thickness: 75 μm).

### Example 2

A polyamide-imide resin film was obtained in the same manner as in Example 1 except that: 0.90 mole of TMA and 0.10 mole of the DIA were used as the acid components (A); and 1,170 parts by weight of NMP were used.

### Example 3

A polyamide-imide resin film was obtained in the same manner as in Example 1 except that: 0.70 mole of TMA and 0.30 mole of the DIA were used as the acid components (A); and 1,780 parts by weight of NMP were used.

### Example 4

A polyamide-imide resin film was obtained in the same manner as in Example 1 except that 0.50 mole of TMA and 0.50 mole of the DIA were used as the acid components (A).

### Comparative Example 1

A polyamide-imide resin film was obtained in the same manner as in Example 1 except that: 1.00 mole of TMA was used as the acid components (A); and 1,060 parts by weight of NMP were used.

### Comparative Example 2

A polyamide-imide resin film was obtained in the same manner as in Example 1 except that 0.10 mole of sebacic acid (SA) was used instead of 0.10 mole of the DIA.

### Comparative Example 3

The same operations as those of Example 1 were performed except that 0.40 mole of TMA and 0.60 mole of the DIA were used as the acid components (A). However, a film having a practically acceptable mechanical strength could not be obtained.

### Evaluation

The polyamide-imide resin films obtained in the examples and the comparative examples were subjected to the following evaluations. Table 1 shows the results.

### (1) Remaining Solvent Amount

A circle having a diameter of 4 mm was cut out of each of the polyamide-imide films obtained in the examples and the comparative examples, and was defined as a sample. The temperature of each sample was increased to 500° C. with a thermogravimetric/differential thermal analyzer (manufactured by Bruker AXS, trade name: TG-DTA 2000SA) at a rate of temperature increase of 10° C./min. Its remaining solvent amount was calculated from its weight reduction amount from 120° C. to 300° C. according to the following equation. When the remaining solvent amount is 2.0% or less, the generation of an outgas from the film can be prevented.

Remaining solvent amount (%)=weight reduction amount/sample weight before heating×100

### (2) Rupture Elongation

A product punched out of each of the polyamide-imide films obtained in the examples and the comparative examples into a dumbbell No. 3 shape was defined as a sample. The sample was evaluated for its rupture elongation with a Tensilon Universal Tester (manufactured by Toyo Baldwin) at a tension speed of 100 mm/min. When the rupture elongation is 60% or more, the film is excellent in processability.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Loading ratio | Trimellitic | 95 | 90 | 70 | 50 | 100 | 90 | 40 |
| of acid | anhydride | | | | | | | |
| component | Dimer acid | 5 | 10 | 30 | 50 | — | — | 60 |
| [mol %] | Sebacic acid | — | — | — | — | — | 10 | — |
| Film | Remaining solvent | 1.78 | 0.15 | 0.12 | 0.1 | 2.12 | 4.95 | Unmeasurable |
| characteristic | amount [%] | | | | | | | |
| | Rupture elongation [%] | 70 | 68 | 107 | 137 | 57 | 44 | Unmeasurable |

As is apparent from Table 1, the polyamide-imide resin films of Examples 1 to 4 each using the acid components containing a specific amount of the dimer acid were reduced in remaining solvent amount without being subjected to a curing step at a high temperature or a long-term curing step. Therefore, those films can each prevent the generation of an outgas from the film. In addition, the polyamide-imide resin films of Examples 1 to 4 had excellent rupture elongations. Accordingly, each of those films had excellent processability and high practical durability.

On the other hand, the polyamide-imide resin films of Comparative Examples 1 and 2 each using the acid components free of the dimer acid had large remaining solvent amounts. Accordingly, there was a possibility that an outgas was generated from each of those films to cause a malfunction or failure in an apparatus or the like. In addition, those films had low rupture elongations, and hence each of the films was difficult to handle, was poor in processability, and had low practical durability.

In addition, when the content of the dimer acid was excessively large (Comparative Example 3), sufficient polymerization reactivity could not be secured and hence a film having a practically acceptable mechanical strength could not be obtained.

The polyamide-imide resin composition of the present invention is used in any appropriate application. The polyamide-imide resin composition of the present invention can provide a film having excellent processability and excellent practical durability. Further, the resultant film can prevent the generation of an outgas from the film. Therefore, the film can be suitably used in: a seamless belt typified by, for example, an intermediate transfer belt, fixing belt, or conveying belt to be used in a copying machine or the like; a heat-resistant film to be used in an electronic part; an insulating coating material to be used in electronic equipment or the like; and a film to be used under a vacuum or under a high-temperature process.

What is claimed is:

1. A polyamide-imide resin composition, comprising a polyamide-imide resin obtained by causing acid components (A) containing a dimer acid and a polyisocyanate component (B) to react with each other, wherein a ratio of the dimer acid in the acid components (A) is 3 mol % to 55 mol %.

2. A polyamide-imide resin composition according to claim 1, wherein the acid components (A) contain a hydrogenated dimer acid.

3. A polyamide-imide resin composition according to claim 1 or 2, wherein the polyisocyanate component comprises contain an aromatic diisocyanate.

4. A polyamide-imide resin composition according to claim 1 or 2, wherein the acid components (A) further contain a tricarboxylic anhydride and a ratio of the tricarboxylic anhydride in the acid components (A) is 90 mol % to 97 mol %.

5. A polyamide-imide resin film, which is obtained by using the polyamide-imide resin composition according to claim 1.

6. A polyamide-imide resin film according to claim 5, wherein the film has a rupture elongation of 60% or more.

7. A polyamide-imide resin film according to claim 5, wherein the film has a remaining solvent amount of 2% or less.

8. A seamless belt, comprising the polyamide-imide resin film according to claim 5.
